(19) United States
(12) Patent Application Publication
(10) Pub. No.: US 2009/0174812 A1
(43) Pub. Date: Jul. 9, 2009

(54) Motion-compressed temporal interpolation

(75) Inventor: Wei Hong, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/164,323

(22) Filed: Jun. 30, 2008

Related U.S. Application Data
(60) Provisional application No. 60/948,215, filed on Jul. 6, 2007.

(51) Int. Cl. H04N 7/01

(52) U.S. Cl. 348/441; 348/E07.003

(57) ABSTRACT

The motion-compensated temporal interpolation using an optical flow defined in an interpolation frame from a subsequent frame, and interpolating from either the prior or the subsequent frame depending upon the divergence of the optical flow.

### CROSS-REFERENCE TO RELATED APPLICATIONS

This application claims priority from provisional application No. 60/948,215, filed Jul. 6, 2007. The following co-assigned pending patent applications disclose related subject matter: various interlaced-to-progressive apps.

### BACKGROUND

The present invention relates to digital video signal processing, and more particularly to devices and methods for video rate conversion.

There are multiple applications for digital video communication and storage, and multiple international standards for video coding have been and are continuing to be developed, such as the H.26x and MPEG-x standards. At the core of all of these standards is the hybrid video coding technique of block motion compensation (prediction) plus transform coding of prediction error. Block motion compensation is used to remove temporal redundancy between successive frames (or fields) by prediction from prior pictures, whereas transform coding is used to remove spatial redundancy within each block of both temporal and spatial prediction errors.

FIGS. 2a-2b illustrate H.264/AVC functions, including rate control in the encoder. Indeed, an encoder for real-time video to be transmitted through a channel with limited capacity can lower the encoded bit rate by increasing the quantization step size to reduce the number of bits per encoded frame and/or by reducing the frame rate such as by discarding frames prior to encoding. Indeed, decreasing a typical input frame rate of 30-60 frames per second (fps) down to 10-15 fps may still provide tolerable video. Furthermore, a decoder can increase the displayed frame rate (up-conversion) of a received low-frame-rate bit stream by creating new frames in-between decoded frames. A higher display frame rate (e.g., up-conversion from 10-15 fps to 30 fps) makes the display more realistic. Decoders typically up-convert by interpolating (with or without motion compensation) the decoded frames to create new in-between frames. In addition, frame rate conversion is important for improving video quality.

Currently, the frame rate of most TVs is 60 Hz in the United States. At this frame rate, rapidly moving objects will appear blurry due to the relative long holding period for each frame. Also, the 3-2 pull-down techniques that current TVs use to convert 24 Hz movie into 60 Hz introduce motion jitter for fast-moving objects. New generations of HDTVs will have frame rates of 120 Hz to conquer flickering. But if the frame rate is just converted from 24 Hz or 60 Hz to 120 Hz using simple frame repetition, motion blur and motion jitter will remain. They can only be eliminated when the new frame is interpolated using motion compensation. See for example, Sugiyama et al., Motion Compensated Frame Rate Conversion Using Normalized Motion Estimation, 2005 IEEE Workshop on Signal Processing Systems Design and Implementation, 663 (November 2005) and Dane and Nguyen, Optimal Temporal Interpolation Filter for Motion-Compensated Frame Rate Up Conversion, 15 IEEE Tran. Image, Proc. 978 (April 2006).

Traditional block motion compensation schemes basically assume that between successive frames an object in a scene undergoes a displacement in the x- and y-directions and these displacements define the components of a motion vector. Thus an object in one frame (field) can be predicted from the object in a prior frame (field) by using the object's motion vector. The motion vector is typically determined by a minimization of the prediction error for the luminance of the pixels in a 16×16 or 8×8 block; that is, if I(x,j) denotes the luminance value for the pixel at x in the j-th frame, then for predicting block A in the j+1-st frame from a block in the j-th frame the motion vector D_{A} is found as:

D_{A}=arg min_{D} Σₓ_{ₑ}^{A} |I(x−D,j)−I(x,j+1)|

For motion-compensated frame rate up-conversion, the motion vector is used to create a block in a new frame in-between two frames by translation of blocks in the two frames, and the motion vector is analogously found by a minimization of translation differences. In particular, for a block B in a new frame mid-way between the j-th frame and the j+1-st frame, find the motion vector as:

D_{B}=arg min_{D} Σₓ_{ₑ}^{B} |I(x−D/2, j)−I(x+D/2, j+1)|

And then the pixel luminance at x in the new block B of the new j+½-th frame would be defined as:

I(x, j+½)=[I(x−D_{B}/2, j)+I(x+D_{B}/2, j+1) ]/2

However, there are problems with the determination of motion vector D_{B} when moving objects occur with uniform backgrounds in the frames to be interpolated for up-conversion.

### SUMMARY OF THE INVENTION

The present invention provides temporal interpolation by definition of an optical flow on an interpolation frame from block motion estimation of a prior or subsequent frame and interpolation using the optical flow. Preferred embodiments select between prior and subsequent frame pixel values according to the divergence of the optical flow.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1a-1d show a preferred embodiment situation and experimental results.

FIGS. 2a-2b show video coding functional blocks.

FIGS. 3a-3b illustrate a processor and packet network communication.

### DESCRIPTION OF THE PREFERRED EMBODIMENTS

### 1. Overview

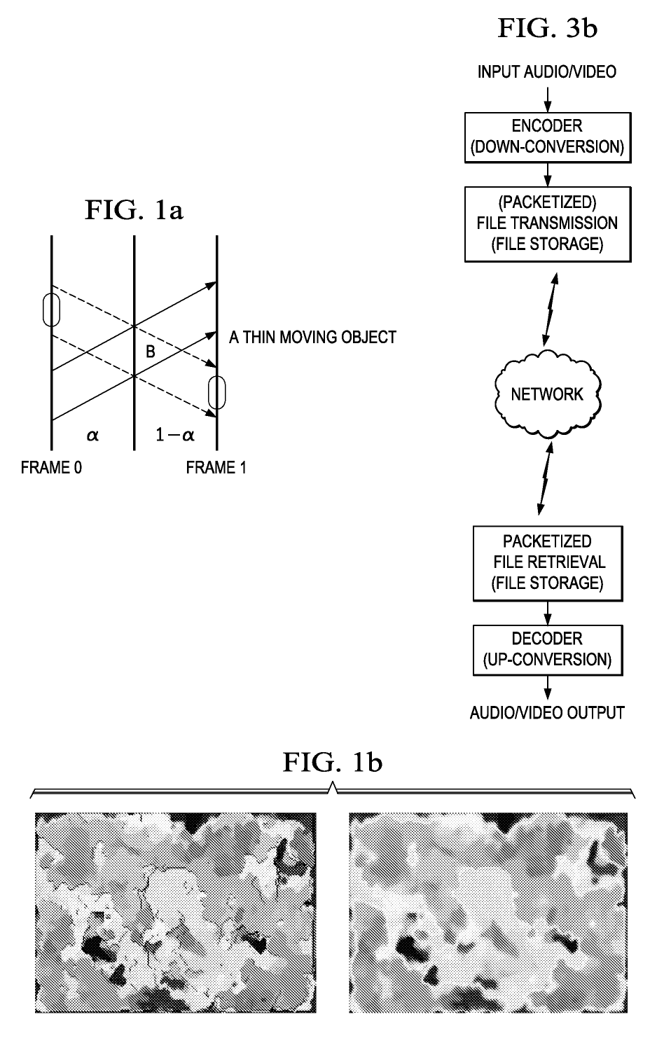

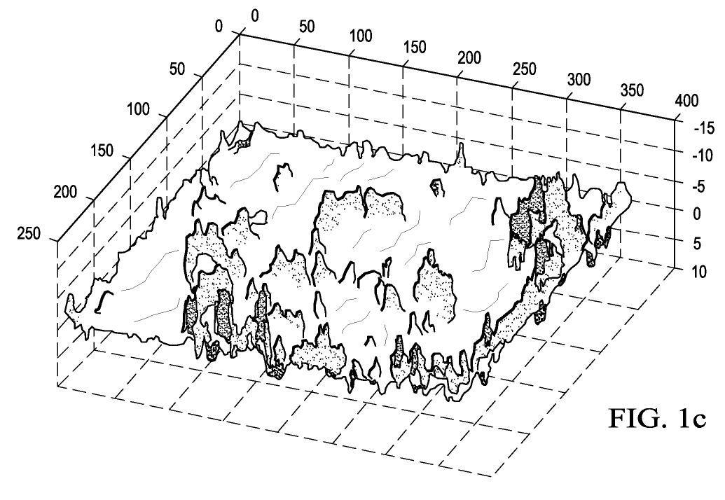

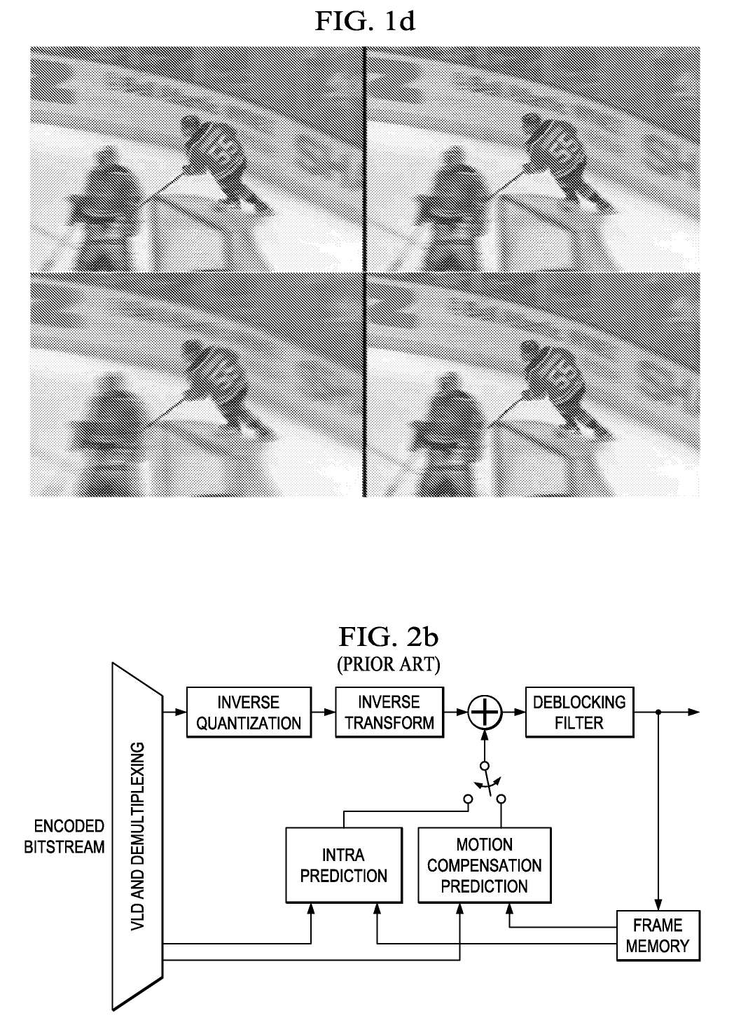

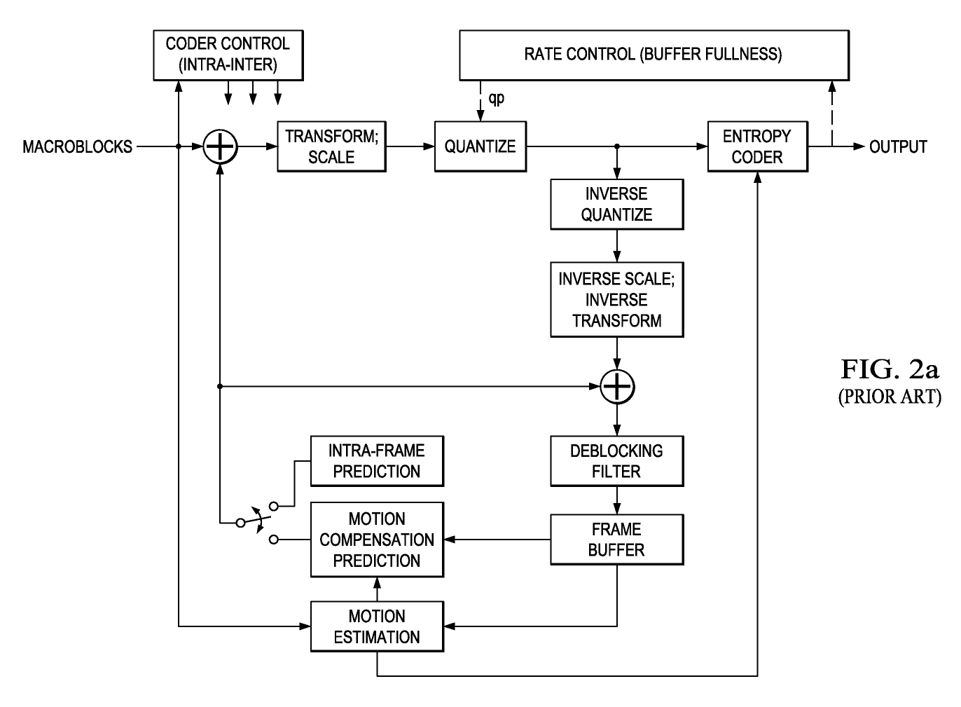

In one embodiment, the method provides a temporal interpolation by definition of an optical flow on an interpolation frame from block motion estimation of a prior or subsequent frame (see FIG. 1b) and interpolation using the optical flow. Further embodiments select between prior and subsequent frame pixel values for interpolated pixel values according to the divergence of the optical flow (see FIG. 1c).

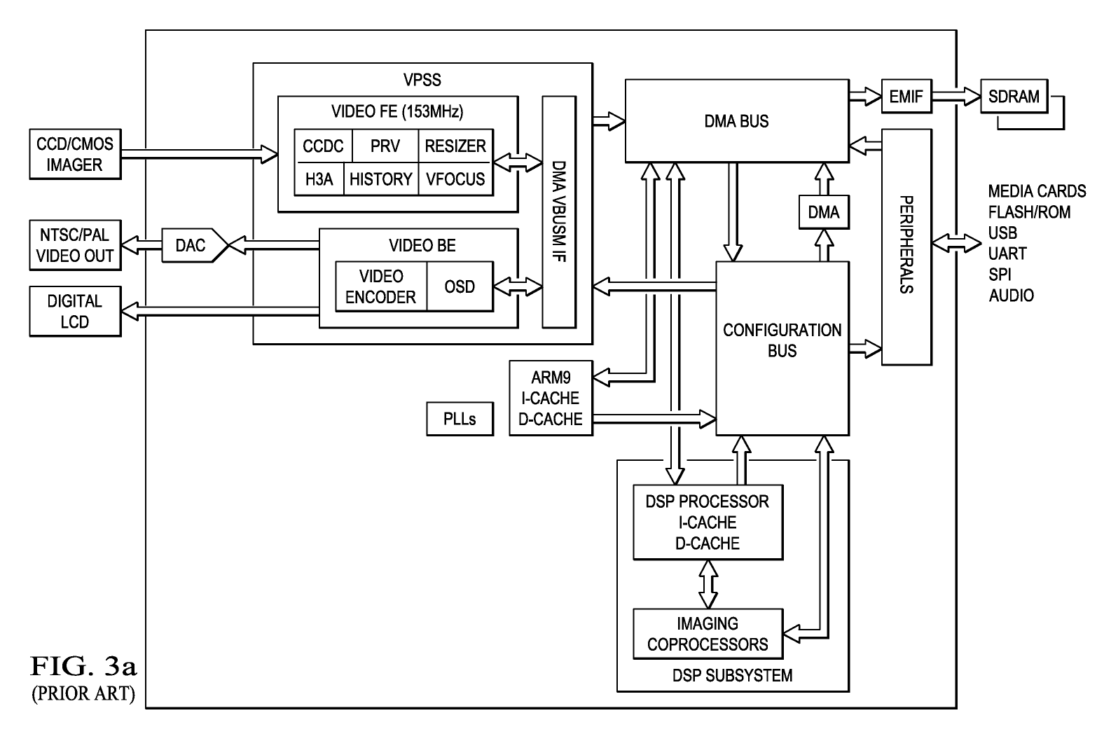

Embodiment systems (e.g., camera cellphones, PDAs, digital cameras, notebook computers, etc.) may perform the above referenced methods with any of several types of hardware, such as, digital signal processors (DSPs), general purpose programmable processors, application specific circuits, or systems on a chip (SoC), such as, multicore processor arrays or combinations such as a DSP and a RISC processor together with various specialized programmable accelerators (e.g., FIG. 3a). A stored program in an onboard or external (flash EEP)ROM or FRAM could implement the signal processing methods. Analog-to-digital and digital-to-analog converters can provide coupling to the analog world; modulators and demodulators (plus antennas for air irnterfaces such as for video on cellphones) can provide coupling for transmission waveforms; and packetizers can provide formats for transmission over networks such as the Internet as illustrated in FIG. 3b.

### 2. Preferred Embodiments

A video sequence consists of a series of frames with each frame an array of (color) pixels; let I(x, t) denote the luminance value of the pixel with x spatial coordinate vector and t temporal coordinate (i.e., the t-th frame). A temporal interpolation problem could be formulated as: given frames I(x, n), for integer times n=1, 2, . . . , then determine frames I(x, t) for arbitrary times t. The preferred embodiment methods only interpolate between two adjacent given frames to determine an in-between frame, so the temporal interpolation problem is simplified to: given I(x, 0) and I(x, 1), determine I(x, α) for 0<α<1. The preferred embodiments provide robust solutions for this problem and will be explained in three stages: (1) motion estimation, (2) optical flow, and (3) frame interpolation.

### (1) Motion Estimation Without Ambiguity for Thin Moving Objects.

Conventional block motion estimation methods estimate a motion vector D_{α,B} corresponding to an image block B in the interpolation frame I(x, α) by minimizing the block sum of absolute differences (SAD):

D_{α,B}=arg min_{D} Σₓ_{ₑ}^{B} |I(x−αD, 0)−I(x+(1−α)D, 1)|

Then D_{α,B} determines the luminance of pixels in block B of the interpolation frame as:

I(x, α)=(1−α) I(x−αD_{α,B}, 0)+αI(x+(1−α)D_{α,B}, 1)

However, the preferred embodiments recognize that this method of motion vector determination will cause an ambiguity when there is a thin moving object with uniform background in the frames I(x, 0), I(x, 1). As the example in FIG. 1a shows, the resultant motion vector can either match the moving object (indicated by the solid downward-sloping arrow) or match the background (indicated by the broken upward-sloping arrow) of the two frames. That is, with a thin moving object in a uniform background, the interpolation block B can be in between both background blocks in I(x, 0), I(x, 1) with small SAD and moving object blocks in I(x, 0), I(x, 1) with small SAD. Thus the motion vector may be ambiguous; and if the background block matching motion vector is picked, the moving object will not appear in the interpolated frame.

To overcome motion vector ambiguity, preferred embodiment methods estimate a motion vector D_{I,A} for each corresponding image block A in the frame I(x, 1). This will avoid missing a thin object in the interpolation frame because every object in frame I(x, 1) will obtain some motion vector(s).

D_{I,A}=arg min_{D} Σₓ_{ₑ}^{A} |I(x−D, 0)−I(x, 1)|

Then let D_{I}(x) denote D_{I,A} when x is in A; that is, define a block motion vector for each x in I(x, 1). But interpolating a frame at time α does require motion information at time α instead of time 1. In stage (2), we will describe an approach to map the block motion vectors at time 1 into an optical flow at time α.
(2) Generate an Optical Flow in the Interpolated Frame from the Block Motion Vectors

An optical flow in frame I(w, α) is computed as:

G(x−(1−α)D_{I}(x))=D_{I}(x)

That is, a pixel at x in I(x, 1) traces back along its motion vector D_{I}(x) to a pixel at w=x−(1−α)D_{I}(x) in the interpolated frame I(w, α), so define a motion vector for the pixel at x−(1−α)D_{I}(x) as D_{I}(x). Since the mapping x→x−(1−α)D_{I}(x) is not subjective, at some positions w in I(w, α) the optical flow G(w) may not be defined after this mapping (e.g., the example in FIG. 1b). These positions are defined as invalid regions. A valid flag, v(w), of a pixel at w in the interpolated frame I(w, α) is defined as:

$$\begin{matrix}v ( w ) = \begin{matrix}1 & if there exists x so that w = x - ( 1 - α ) {D}_{1} ( x )\end{matrix} \\ = \begin{matrix}0 & otherwise\end{matrix}\end{matrix}$$

A special 2-D separable moving average filter will be applied to the optical flow with invalid regions. The filter is defined as:

F(w)=Σₓ_{ₑ}^{C} G(x)v(x)/Σₓ_{ₑ}^{C} v(x) for all w.

where C is a window around w. This filter will interpolate the optical flow for invalid regions. It will also eliminate blocking effects of the optical flow caused by the block motion estimation.

The two panels of FIG. 1b show an example of (the x-component of) the created optical flow vectors. Left panel: at some positions x, the optical flow Gₓ(x) may not get any value. Right panel: the optical flow Fₓ(x) after the special 2-D moving average filter. The invalid regions and blocking effects are eliminated.

The optical flow could then be used for interpolation as before:

I(x, α)=(1−α) I(x−αF(x), 0)+α I(x+(1−α)F(x), 1)

However, other preferred embodiments have a different interpolation as described in following stage (3).

### (3) Frame Interpolation Using Vector Divergence

A challenging problem for interpolation methods is dealing with occlusion. The preferred embodiment methods can handle occlusion automatically by using the divergence of the optical flow. The divergence is an operator that measures a vector field's tendency to originate from (diverge) or converge upon a position. At each position

$$x = [ \begin{matrix}x \\ y\end{matrix} ] ,$$

the divergence of the optical flow is:

divF(x)=∂Fₓ(x)/∂x+∂F_{y}(x)/∂y

The divergence divF(x) is approximately proportional to Fₓ(x+δ, y)−Fₓ(x−δ, y)+F_{y}(x, y+δ)−F_{y}(x, y−δ), and this provides a computation method by setting δ=1˜5. FIG. 1c shows an example of the divergence map of the optical flow.

When divF(x)<0, object covering (occlusion) is likely occurring in I(x, α), so that the pixel value from the frame I(x, 0) is more reliable than from I(x, 1). Conversely, when divF(x)>0, uncovering is likely occurring, so that the pixel value from frame I(x, 1) is more reliable. Thus, preferred embodiment methods compute pixel values for the interpolated frame by

$$I ( x , α ) = \{ \begin{matrix}I ( x - α F ( x ) , 0 ) & if divF ( x ) \leq 0 \\ l ( x + ( 1 - α ) F ( x ) , 1 ) & if divF ( x ) > 0\end{matrix}$$

Normally, x−αF(x) or x+(1−α)F(x) does not have integer values. So a 2-D 7-tap polyphase filter is applied to interpolate the pixel value at x−αF(x) or x+(1−α)F(x) from an 8 by 8 window around it.

In one embodiment, the method of motion-compensated temporal interpolation (e.g., for frame rate up-conversion) between a first frame and a second frame include the steps of determine block motion vectors for pixels of the second frame; define a first optical flow of an interpolation frame from said block motion vectors; define a second optical flow of said interpolation frame by filtering said first optical flow; compute a divergence of said second optical flow; when said divergence is positive at a target pixel of said interpolation frame, define a value for said target pixel from pixel values in said second frame; and
(f) when said divergence is negative at a target pixel of said interpolation frame, define a value for said target pixel from pixel values in said first frame.

### 3. Experimental Results

An example of the temporal interpolation is shown in FIG. 1d. There are several moving objects with different speeds in the scene. The motion-compensated interpolation generates visually much, more pleasant result than the non-motion-compensated interpolation. In FIG. 1d, Top-left panel: the frame 0. Top-right panel: the frame 1. Bottom-left panel: non-motion-compensated interpolation (frame averaging) at α=0.5. Bottom-right panel: motion-compensated interpolation at α=0.5.

### 4. Modifications

The preferred embodiments may be modified in various ways while retaining one or more of the features of interpolation with an optical flow.

For example, the interpolation may be on a field basis, bi-linear interpolation of the surroundings optical flow vectors can be used for generating optical flow vectors for invalid regions, higher-order filters could be used for the optical flow filtering, the divergence could be computed with a larger window of optical flow values, when the divergence is 0 either the prior or the subsequent frame or their average could be used, the optical flow could be defined from the prior frame in place of the subsequent frame, the optical flow and divergence map can be down-sampled to save computation and bandwidth, the 7-tap interpolation filter could be applied along edge direction, and so forth.

While the foregoing is directed to embodiments of the present invention, other and further embodiments of the invention may be devised without departing from the basic scope thereof, and the scope thereof is determined by the claims that follow.

What is claimed is:

1. A method of temporal interpolation between a first frame and a second frame, comprising the steps of:
(a) determining block motion vectors for pixels of said second frame;
(b) defining a first optical flow of an interpolation frame from said block motion vectors;
(c) defining a second optical flow of said interpolation frame by filtering said first optical flow;
(d) computing a divergence of said second optical flow;
(e) when said divergence is positive at a target pixel of said interpolation frame, defining a value for said target pixel from pixel values in said second frame; and
(f) when said divergence is negative at a target pixel of said interpolation frame, defining a value for said target pixel from pixel values in said first frame.

2. The method of claim 1, wherein the frame relates to at least one of an image or a video.

3. An apparatus for data processing, comprising:
(i) a frame decoder; and
(ii) a frame interpolator coupled to said frame decoder, said frame interpolator to generate an interpolation frame between a first decoded frame and a second decoded frame output from said frame decoder, said frame interpolator operable to:
(a) determine block motion vectors for pixels of said second decoded frame;
(b) compute a first optical flow for said interpolation frame from said block motion vectors;
(c) compute a second optical flow of said interpolation frame by filtering said first optical flow;
(d) compute a divergence of said second optical flow;
(e) when said divergence is positive at a target pixel of said interpolation frame, compute a value for said target pixel from pixel values in said second decoded frame; and
(f) when said divergence is negative at a target pixel of said interpolation frame, compute a value for said target pixel from pixel values in said first decoded frame.

4. The apparatus of claim 3, wherein the frame relates to at least one of an image or a video.
